(19) United States
(12) Patent Application Publication
(10) Pub. No.: US 2025/0233872 A1
(43) Pub. Date: Jul. 17, 2025

(54) DYNAMIC SECURITY MONITORING OF USER ACTIVITIES IN NETWORKED BACKUP STORAGE SYSTEMS

(71) Applicant: Dell Products L.P., Round Rock, TX (US)

(72) Inventors: Madhu Agrahara Gopalakrishna, Pleasanton, CA (US); Mahadev Karadigudda, San Jose, CA (US); Niharika Avasarala, Pleasanton, CA (US); Praveen Kumar Lakkimsetti, Dublin, CA (US); Sankalp Suhas Taralekar, Santa Clara, CA (US)

(73) Assignee: Dell Products L.P., Round Rock, TX (US)

(21) Appl. No.: 18/953,963

(22) Filed: Nov. 20, 2024

Related U.S. Application Data
(63) Continuation-in-part of application No. 18/673,012, filed on May 23, 2024.
Application No. 18/673,012 is a continuation-in-part of application No. 18/410,286, filed on Jan. 11, 2024.

(51) Int. Cl. H04L 9/40

(52) U.S. Cl. CPC H04L 63/1416; H04L 63/1433

(57) ABSTRACT

A system trains machine-learning models to identify historical activities, performed by users of backup storage systems, which include atypical activities and/or resemblances to malicious activities. The machine-learning models identify activities, performed by a user of a backup storage system, which include any of the atypical activities or a resemblance to any of the malicious activities. The system determines activity scores corresponding to the identified activities, wherein each activity score is related to a corresponding level of security risk. The system outputs a security health score based on the activity scores. If the security health score is less than a threshold, the system isolates the backup storage system and enables another backup storage system to output another security health score based on one of the activity scores associated with the backup storage system. The system outputs an updated security health score based on any change to any identified activity.

### CROSS REFERENCE TO RELATED APPLICATION

This application is a continuation-in-part of U.S. patent application Ser. No. 18/673,012, filed May 23, 2024, which is a continuation-in-part of U.S. patent application Ser. No. 18/410,286, filed Jan. 11, 2024, both of which are incorporated herein by reference in their entirely as if set forth in full herein.

### BACKGROUND

Computer security, cybersecurity, digital security or information technology security (IT security) is the protection of computer systems and networks from attacks by malicious actors that may result in unauthorized information disclosure, theft of, or damage to hardware, software, or data, as well as from the disruption or misdirection of the services they provide. To secure a computer system, it is important to understand the attacks that may be made against it, with these attacks including malware, phishing, and direct attacks.

Malware (malicious software) is any software code or computer program intentionally written to harm a computer system or its users. Once present on a computer, malware can leak sensitive details such as personal information, business information and passwords, can give control of the system to an attacker, and can corrupt or delete data permanently. One type of malware is ransomware, which is when malware installs itself onto a victim's machine, encrypts their files, and then demands a ransom (usually in Bitcoin) to return that data to the user. Other types of malware also include viruses, worms, trojan horses, spyware, and scareware.

Viruses are a specific type of malware, and are normally a malicious code that hijacks software with the intension to do damage and spread copies of itself. Copies are made with the aim to spread to other programs on a computer.

Worms are similar to viruses, however viruses can only function when a user runs or opens a compromised program. Worms are self-replicating malware that spread between programs, applications, and devices without the need for human interaction.

Trojan horses are programs that pretend to be helpful or hide themselves within desired or legitimate software to trick users into installing them. Once installed, a RAT (remote access trojan) can create a secret backdoor on the affected device to enable access by an attacker who can cause damage.

Spyware is a type of malware that secretly gathers information from an infected computer and transmits the sensitive information back to an attacker. One of the most common forms of spyware are keyloggers, which record all of a user's keyboard inputs/keystrokes, which allows hackers to harvest usernames, passwords, and bank account and credit card numbers.

Scareware, as the name suggests, is a form of malware which uses social engineering or manipulation to scare, shock, trigger anxiety, or suggest the perception of a threat in order to manipulate users into buying or installing unwanted software. These attacks often begin with a sudden pop-up with an urgent message, usually warning the user that they have broken the law or their device has a virus.

Phishing is the attempt of acquiring sensitive information such as usernames, passwords, and credit card details directly from communication system users by deceiving the users. Phishing is typically carried out by email spoofing, instant messaging, text message, or on a phone call. Users are directed to enter details at a fake website which appears almost identical to the legitimate website. The fake website often asks for personal information, such as login details and passwords. This information can then be used to gain access to the individual's real account on the real website.

Preying on a victim's trust, phishing may be classified as a form of social engineering. Attackers can use creative ways to gain access to real accounts. A common scam is for attackers to send fake electronic invoices to individuals, which alleges that the individual recently purchased music, applications, or other items, and instructs the individual to click on a link if the purchases were not authorized. A more strategic type of phishing is referred to as spear-phishing, which leverages personal or organization-specific details to make the attacker appear as a trusted source. Spear-phishing attacks specific individuals, rather than the broad net cast by phishing attempts.

A direct-access attack is when an attacker who is an unauthorized user gains physical access to a computer, most likely to directly copy data from the computer or to steal information. Attackers may also compromise security by making operating system modifications, installing software worms, keyloggers, covert listening devices, or using wireless microphones. Even when a computer system is protected by standard security measures, these measures may be bypassed by booting another operating system or tool from a CD-ROM or other bootable media. Disk encryption and trusted platform module are designed to prevent these attacks.

Direct service attackers are related in concept to direct memory attacks which allow an attacker to gain direct access to a computer's memory. The attacks take advantage of a feature of modern computers that allows certain devices, such as external hard drives, graphics cards or network cards, to access a computer's memory directly. To help prevent these attacks, computer users must ensure that they have strong passwords, that their computer is locked at all times when they are not using it, and that they keep their computer with them at all times when traveling.

Security misconfiguration is one of the most significant contributors for data storage systems being vulnerable to malware, phishing, and direct attacks, and can lead to catastrophic data loss. To avoid security breaches, it is important to analyze all potential security gaps and take corrective actions, as necessary. Multiple cases have demonstrated that practices such as continuing to use default passwords and the failure to enable additional security safeguards have resulted in serious consequences for the security of data storage systems. Multiple factors can contribute to the overall security of a backup storage system.

### BRIEF DESCRIPTION OF THE DRAWINGS

FIG. 1 illustrates a block diagram of an example system for dynamic security monitoring of user activities in networked backup storage systems, under an embodiment;

FIG. 2 is a flowchart that illustrates an example method for a dynamic security monitor for a backup storage system, under an embodiment;

FIG. 3A-3B are block diagrams that illustrate example dashboards for a dynamic security monitor for a backup storage system, under an embodiment;

FIG. 4 is a flowchart that illustrates an example method for dynamic security monitoring of user activities in networked backup storage systems, under an embodiment;

FIG. 5 is a block diagrams that illustrates another example dashboard for dynamic security monitoring of user activities in networked backup storage systems, under an embodiment; and

FIG. 6 is a block diagram illustrating an example hardware device in which the subject matter may be implemented.

### DETAILED DESCRIPTION

A dynamic security monitor can monitor a backup storage system, detect specific user activities which are atypical or resemble malicious activities, initiate an in-depth analysis to understand the nature and extent of the specific user activities, and generate corresponding security alerts. A management center can manage a network of a large number of backup storage systems in similar environments, and extend a security alert from one backup storage system to the other backup storage systems in the network, and adjust the sensitivity of the other backup storage systems to the specific user activities that triggered the security alert, thereby enhancing the network security. For example, the specific user activities could be unauthorized access by a malicious actor attempting to exploit a vulnerability in a backup storage system via unauthorized access attempts, and/or unusual data transfers.

Upon confirmation of the security alert, an automated response system extends security measures to all backup storage systems in the network by lowering specific activity scores, increasing specific weights of activity scores, and/or adjusting thresholds for security health scores. The automated response system isolates the affected backup storage system from the rest of the backup storage systems in the network to prevent the spread of the effect of the specific user activities by disabling network access, blocking suspicious processes, and/or implementing firewall rules to contain the threat. Then the automated response system can initiate the deployment of security updates, patches, and/or configuration changes across all backup storage systems within the network, which ensures that known vulnerabilities are addressed promptly, reducing the risks created by the specific user activities for the other backup storage systems.

The network of backup storage systems applies automated remediation measures as necessary to address emerging threats and maintain the integrity of the network. After the initial response, the network of backup storage systems continuously monitors user activities to detect any further suspicious activities. The continuous monitoring and proactive remediation help enhance the overall resilience of the network against evolving security threats.

The automated response system ensures swift action to mitigate the impact of any detected security breaches across the entire network, minimizes the risk of further exploitation of vulnerabilities, and reduces the manual effort required for incident response, allowing security teams to focus on more strategic tasks. The automated response system is designed with granular control to ensure that security measures are applied appropriately based on the severity and nature of any detected security breach. The automated response system complies with relevant regulatory requirements and organizational policies to avoid potential compliance issues.

Embodiments of the present disclosure provide dynamic security monitoring of user activities in networked backup storage systems. A system trains machine-learning models to identify historical activities, performed by users of backup storage systems, which include atypical activities and/or resemblances to malicious activities. The machine-learning models identify activities, performed by a user of a backup storage system, which include any of the atypical activities or a resemblance to any of the malicious activities. The system determines activity scores corresponding to the identified activities, wherein each activity score is related to a corresponding level of security risk. The system outputs a security health score based on the activity scores. If the security health score is less than a threshold, the system isolates the backup storage system and enables another backup storage system to output another security health score based on one of the activity scores associated with the backup storage system. The system outputs an updated security health score based on any change to any identified activity.

For example, Acme Corporation uses a server to train machine-learning models to identify Acme employees' access of data from Acme's backup storage system in unusual ways and to identify various malware attacks on Acme's backup storage system. The trained machine-learning models identify the amounts of data accessed, the rates of data accessed, and the transferring of files as usual activities for an Acme employee, and do not recognize any malware signatures or attack patterns in the backup storage system. However, since the Acme employee had almost always logged into the backup storage system from his desk at Acme headquarters during normal business hours, the machine-learning models identify the Acme employee apparently logging into the backup storage system from a location outside of work as a slightly unusual activity, and also identify logging in at midnight on a Saturday as a slightly unusual activity. The machine-learning models additionally identify the Acme employee's commands to significantly increase the amounts of files transferred as slightly resembling many ransomware attacks which transfer large amounts of files within backup storage systems before encrypting the data in the files, and then transferring the encrypted data back to its previous locations within the backup storage systems.

Acme's dynamic security monitor assigns activity scores of 9 to most of the activity scores, an activity score of 8 to the unusual login time, an activity score of 8 to the unusual login location, and an activity score of 7 to the Acme employee's commands for significant increases in the amounts of data files transferred, which slightly resemble malware commands. Even though none of the individual activity scores would have been sufficient to individually trigger an alert threshold, the dynamic security monitor used the combination of activity scores to collectively generate a security health score of 80 that is low enough to trigger the fair security health threshold. Since the activity score for data files transferred contributed the most towards the security health score of 80 falling below the good security health threshold, the dynamic security monitor enables the other backup storage systems in the network to be more sensitive to the probability of generating a similar alert by temporarily reducing their activity scores for the data files transferred by 10% and temporarily raising the poor security health threshold for networked backup storage systems from 60 to 70. If the other backup storage systems in the network do not generate a similar alert and the security risk caused by the Acme employee is resolved, the backup storage system's dynamic security monitor outputs an updated security health score of 100 percent based on the improvement in the activities used to determine the activity scores for the employee's login time, the employee's login location, and the employee's at least temporarily diminished use of transfer commands. The dynamic security monitors for Acme's networked backup storage systems continue to monitor all of the activities when Acme employees access data from Acme's networked backup storage systems in unusual ways and when various malware attacks Acme's networked backup storage systems.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. In some embodiments, operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

### Exemplary Environments

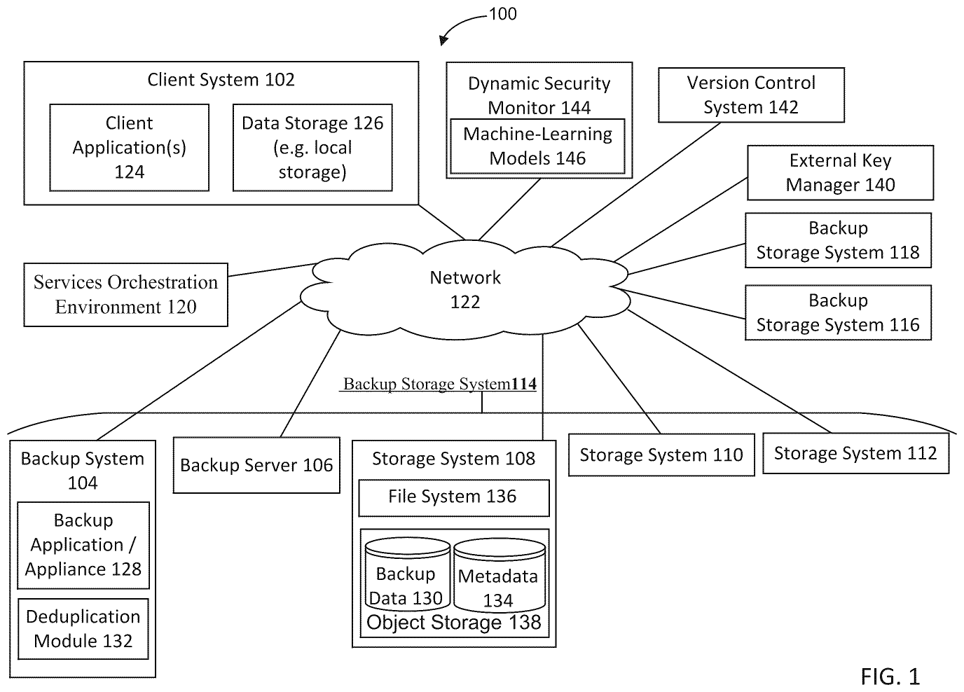

FIG. 1 depicts a block diagram which illustrates an example of an operating environment 100 for dynamic security monitoring of user activities in networked backup storage systems according to one or more embodiments of the disclosure. As shown, the operating environment 100 may include a client system 102, which may be backed up by a backup system 104, a backup server 106, and a cluster of storage systems 108-112, which may be referred to collectively as a backup storage system 114, such that the term “backup storage system” may refer to any combination of the components 104-112. The backup storage system 114 is substantially similar to the backup storage systems 116 and 118, which are served by a services orchestration environment 120, and, along with the client system 102, may interact via a network 122, which may be any type of wired or wireless network including a local area network (LAN), a wide area network (WAN), or a direct communication link, or other suitable connection.

As shown, the operating environment 100 may include a client or client system (or computer, or device) 102 that may be associated with a system user of a data backup and protection service, and the backup system 104 that may be associated with a data backup and protection service provider. For example, the client system 102 may provide computing resources (such as databases) for customers (such as website visitors) of a system user, and data which may be protected by the backup and data protection service provider. Accordingly, the client system 102 may function as a client from which backups are performed. In some embodiments, the client system 102 may comprise a virtual machine.

In addition, the client system 102 may host one or more client applications 124, and may include data storage 126, as well as an interface for communicating with other systems and devices, such as the backup system 104. In general, the client applications 124 may create new and/or modified data that is desired to be protected. As such, the client system 102 is an example of a host device. The data storage 126 may be used to store client data, which may, along with the client system 102 (such as the client applications 124), be backed up using the backup system 104.

As further described herein, components of the client system 102 (such as the client applications 124 and the data storage 126) may be a data source, or be associated with one or more data sources such as a database, a virtual machine, and a storage device. In addition, components of the client system 102 may be data sources that are associated with the client system 102, but these components may reside on separate servers, such as a data server, or a cloud-computing infrastructure. The client system 102 may include a backup client application, or plug-in application, or Application Programming Interface (API) that cooperates with the backup system 104 to create backups of client data. The backed-up data can also be restored to the client system 102.

In at least one embodiment, the backup system 104 may represent one or more components of a Data Domain Restorer-based deduplication storage system, and a backup server 106 may be implemented in conjunction with a Data Domain deduplication storage server provided by Dell EMC for use with Data Domain Restorer storage devices. For example, the backup server 106 may be a stand-alone entity, or may be an element of the cluster of storage systems 108-112. In some embodiments, the backup server 106 may be a Dell EMC Avamar server or a Dell EMC Networker server, although no particular server is required, and other backup and storage system configurations are contemplated.

The backup system 104 may include a backup application (or appliance) 128 that performs, manages, or coordinates the creation and restoration of data that may be backed-up. For example, data to be backed-up from the client system 102 may be communicated from the client system 102 to the backup application 128 for initial processing, after which the processed data, such as backup data 130, is uploaded from the backup application 128 for storage at the cluster of storage systems 108-112. In some embodiments, the backup application 128 may cooperate with a backup client application of the client system 102 to back up client data to the cluster of storage systems 108-112. The backup application 128 may also cooperate with a backup client application to restore backup data from the cluster of storage systems 108-112 to the client system 102.

In some embodiments, the backup application 128 may be a part of, or work in conjunction with, a storage appliance. For example, the storage appliance may include a Dell EMC Cloud Boost appliance, or any suitable appliance. In addition, the backup application 128 may provide a variety of useful functionalities such as source-side data deduplication, data compression, and wide area network (WAN) optimization boost performance and throughput, while also possibly reducing the consumption and cost of network bandwidth and cloud storage capacity.

One, some, or all, of these functions of the backup application 128 may be performed using deduplication logic via a deduplication module 132. For example, the deduplication module 132 can provide data segmentation, as well as in-flight encryption as the data is sent by the backup application 128 to the cluster of storage systems 108-112. However, as further described herein, in some embodiments, data deduplication may be performed entirely within the cluster of storage systems 108-112. It should be noted that the backup application (or storage appliance) 128 may be implemented in various forms, such as a virtual, physical, or native public cloud appliance to fit the requirements of a particular configuration, and the backup application 128 may be used with distinct types of data protection environments, including public and private object storage clouds.

The storage system 108, which is substantially similar to the storage systems 110-112, may store backup data 130 (backup files or backup objects) within a one or more computer nodes, as further described herein. As shown, the storage system 108 may also store metadata 134 for (or associated with) the backup data 130, and one or more instances of a filesystem 136 that catalogs backup files and other data residing in the clustered environment. In general, the storage of the backup data 130 may be configured to store data backups for the client system 102, which may be restored in the event of a loss of data.

The storage system 108 may be a file storage system or an object storage system that includes a file system 136 for file storage or an object storage system for object storage 138. Each storage system of the cluster of storage systems 108-112 may store backup data and/or metadata for the backup data within one or more computer nodes, and any combination of these computer nodes may be various types of computer nodes for a data center.

The operating environment 100 also includes an external key manager 140, a version control system 142, and a dynamic security monitor 144. The external key manager 140 can provide encryption keys that a backup storage system can use to encrypt data at rest. Since a system user may rotate encryption keys periodically for security reasons, a backup storage system may provide the options to automatically rotate encryption keys periodically by setting up encryption key rotation policies. The version control system 142 maintains and distributes copies of versions of applications, such as various software releases of the Data Domain operating system, and patches which correct any security vulnerabilities discovered between the versions of the software releases. For example, the version control system 142 may distribute the Data Domain operating system version 7.12, distribute a patch 7.12.1 for version 7.12, and then distribute a second patch 7.12.2 for version 7.12 before subsequently distributing the Data Domain operating system version 7.13.

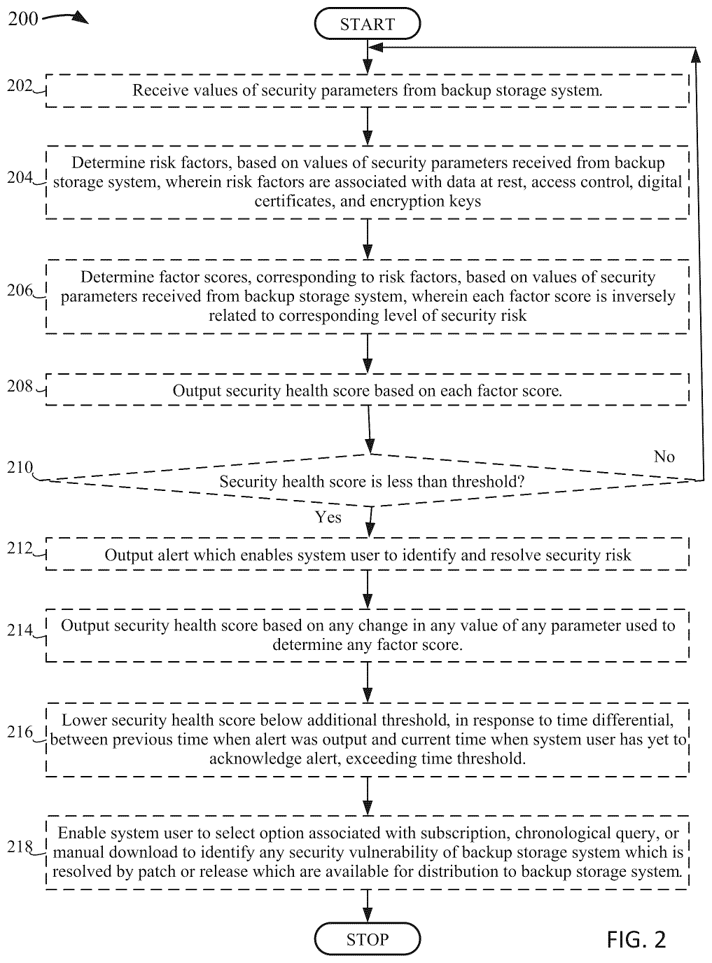

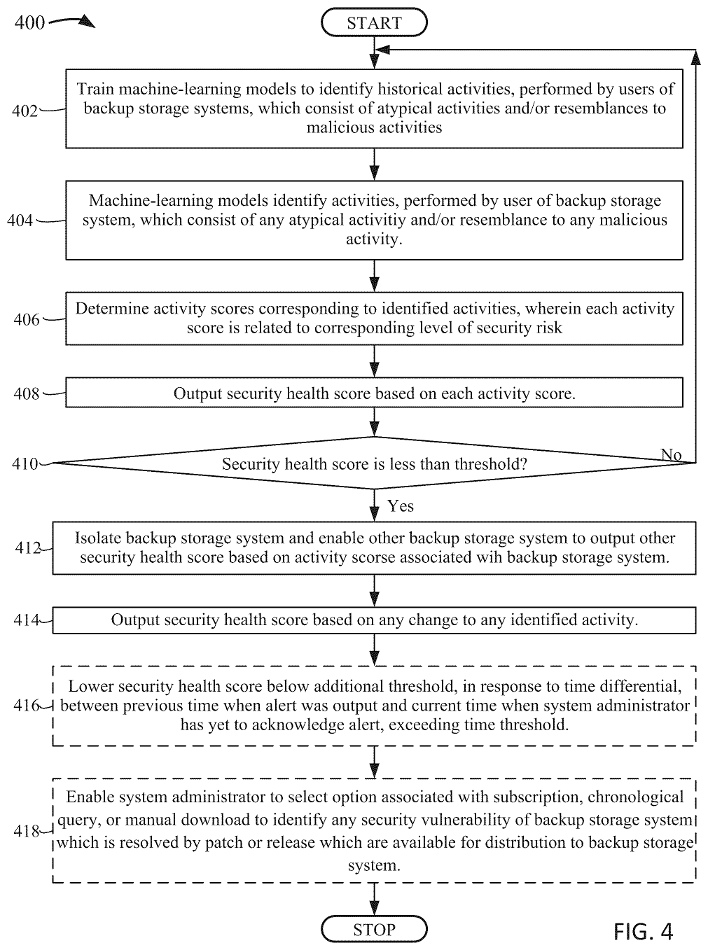

The dynamic security monitor 144 can include data mining tools such as a Data Domain analyzer that performs analysis on auto-support bundles which a backup storage system provides as raw values for all the security parameters. The dynamic security monitor 144 can apply Artificial Intelligence/machine-learning models 146, such as a LSTM [Long Short-Term Memory] network, to mine historic data, such as a time series, to detect patterns and make predictions which risk factors may become potential threats for security in the coming future, and therefore change the algorithm for determining the security health score to incorporate a newly discovered risk factor in the updated calculations of a revised security health score. In an example, if any of the machine-learning models 146 detects a pattern of security attacks being more frequent in the month of December in 2021 and 2022, then there is a possibility of poor security health score in December 2023. Such predictions can help alert a system user beforehand. The dynamic security monitor 144 can also generate dynamic security health scores for a backup storage system, and the machine-learning models 146 can identify activities associated with the backup storage systems 114-118, wherein the identified activities can include atypical activities or resemble malicious activities, as described below in reference to FIG. 2 and FIG. 4.

FIG. 2 is a flowchart 200 that illustrates a method for a dynamic security monitor for a backup storage system, in an embodiment. Flowchart 200 depicts method acts illustrated as flowchart blocks for certain steps involving the client 102, the backup storage system 118, and the dynamic security monitor 144 of FIG. 1.

Values of security parameters are optionally received from a backup storage system, block 202. The system can receive security information from a backup storage system. For example, and without limitation, this can include the dynamic security monitor 144 receiving and analyzing the auto-support security parameters that a system user opted to provide from the backup storage system used by the system user.

A value can be a numerical amount or a meaning of an object, quantity, or expression. A security parameter can be a numerical or other measurable element forming one of a set that defines a system or sets the conditions of its operation to be free from danger or threat. A backup storage system can be an electronic device that retains a copy of computer information.

After receiving values of security parameters from a backup storage system, risk factors, which are based on the values of the security parameters received from the backup storage system, are optionally determined, wherein the risk factors are associated with data at rest, access control, digital certificates, and encryption keys, block 204. The system can identify the risk factors in the security information from the backup storage system. By way of example and without limitation, this can include the dynamic security monitor 144 identifying risk factors which are associated with a data at rest encryption status, a security officer configuration, a digital certificate revocation status, an encryption key rotation frequency, a connectivity with an external data manager, an alert mechanism status, and a passphrase level.

A risk factor can be an influence that involves system exposure to danger and that contributes to a result or outcome. Data at rest can be computer information stored on an electronic device. Access control can be the power to influence or direct the action or process of obtaining or retrieving information stored in a computer's memory. A digital certificate can be a an electronic document or file that proves the authenticity of an encryption key. An encryption key can be a variable value that is applied using an algorithm to a string or block of uncoded text to produce coded text.

Risk factors associated with data at rest can include an encryption key rotation frequency and whether encryption is enabled for data at rest. In a backup storage system, a system user can set a weekly or monthly encryption key rotation policy and the expectation is that any one of several supported key managers such as the external key manager 140 will rotate encryption keys at that frequency. If encryption is not enabled on a backup storage system, then data at rest is not encrypted.

An encryption key rotation frequency can be a rate for exchanging a variable value that is applied using an algorithm to a string or block of uncoded text to produce coded text. Encryption can be a process of converting information or data into a code, especially to prevent unauthorized access. Enabled can be adapted for use with a specified application or system.

Risk factors associated with access control can include whether a security officer is configured and a level of privileges which are configured for the security officer. Sometimes the security officer is not configured on a backup storage system. If a security office is configured on a backup storage system, the setting of various levels of privileges for the security officer may be one of the risk factors in the backup storage system.

A security officer can be a person holding a position of command or authority with a goal to make something free from danger or threat. Configured can be an arrangement of a computer system or element so as to be fit for a designated task. A level can be a position on a real or imaginary scale of amount, quantity, extent, or quality. A privilege can be a special right or advantage granted or available only to particular people and/or groups.

Risk factors associated with digital certificate can include a digital certificate expiration frequency and whether a digital certificate has been revoked. A digital certificate expiration frequency may be a risk factor for a backup storage system because electronic passwords may be invalidated too soon or too late for the security of the backup storage system. Additionally, sometimes digital certificates can get revoked on a backup storage system, and self-signed certificate versus external signed certificate may be considered as a part of this risk factor. A digital certificate expiration frequency can be a rate of invalidating a file or electronic element that proves the authenticity of a device, server, or user through the use of cryptography. Revoke can be to put an end to the validity or operation of something.

Risk factors can be associated with whether an alert mechanism is enabled, and a security level of a system passphrase. If an alert mechanism is enabled, alerts may be raised in case of security compromised events, which therefore can prompt a system user to improve the security of a backup storage system. A strong passphrase will help improve the security of a backup storage system, while a weak passphrase may be reported as a risk factor that weakens the overall security of the backup storage system.

An alert mechanism can be a system of components working together in an electronic device for an announcement or signal warning of danger. A security level can be a position on a real or imaginary scale of amount, quantity, extent, or quality of a goal to be free from danger or threat. A system passphrase can be a string of characters and/or symbols that must be used to gain access to a computer system or service.

Risk factors can also be associated with whether cloud provider encryption is enabled, and an authentication level for digital certificates. If cloud provider encryption is enabled, but encryption is not enabled for data at rest on a backup storage system, this encryption may be recorded and thus is not included in the evaluation of risk factors for a backup storage system. In a backup storage system that has replication setup, two-way certificate authentication can have a beneficial impact on the overall security of the backup storage system, one-way certificate authentication can have a somewhat neutral impact on the overall security of the backup storage system, and encryption that is not enabled can have a negative impact on the overall security of the backup storage system. Cloud provider encryption can be on-demand availability of computer system resources for the process of converting information or data into a code, especially to prevent unauthorized access. An authentication level can be a position on a real or imaginary scale of amount, quantity, extent, or quality for having a submitted identity verified.

A risk factor may be based on a time differential between a previous time when a patch or a software release became available for the backup storage system and a current time when the patch or the software release has yet to be installed on the backup storage system. For example, the longer that a system user ignores an alert about a patch that resolves an issue with system passwords, the lower the dynamic security monitor 144 will reduce the security health score, which triggers successive alerts about the security vulnerability resolved by the patch.

A time differential can be a distinction in amounts of things as measured in hours and minutes past midnight or noon. A previous time can be the past, which was existing or previously occurring, as measured in hours and minutes past midnight or noon. A patch can be a small piece of code that may be inserted into a program to improve its functioning or to correct an error. A software release can be a distribution of a computer application in an application distribution life cycle.

Available can be the ability to be used or obtained. A current time can be the present as measured in hours and minutes past midnight or noon. An installation can be the act of establishing an electronic device in a condition that is ready for future use.

Similarly, a risk factor may be based on a time differential between a previous time when a new version of a backup storage system's operating system became available and a current time when the new version of the backup storage system's operating system has yet to be installed on a specific system. For example, the longer that a system user ignores an alert about security risks that could be resolved by purchasing and then installing the new version of the backup storage system's operating system, the lower the dynamic security monitor 144 will reduce the value used for generating the score that triggers the alert about the risk factor resolved by the new version of the backup storage system's operating system.

An external key manager 140 that periodically provides encryption keys to a backup storage system should be online continuously to ensure that periodic encryption key rotation takes place reliably. In case this frequency is less often than monthly, a large amount of data may be encrypted with a single encryption key, and failure to rotate keys in the expected time window can occur because of the various issues. Therefore, risk factors may be associated with these encryption key issues, such as whether the external key manager 140 has an issue with a connectivity to a backup storage system, an issue with digital certificates, an issue with an encryption key class, an issue with a transport security layer parameter, an issue with a non-existent encryption key, and/or an issue with an external key manager user. An external key manager can be an electronic device responsible for controlling or administering a variable value that is applied using an algorithm to a string or block of uncoded text to produce coded text. An issue can be an important problem.

Connectivity issues are a common problem when an external key manager's server is offline, and a backup storage system has issues with reaching this server. These connectivity issues can occur because of an incorrect port, a transport security layer version mismatch if the external key manager's server does not use the same version of transport security layer that the backup storage system uses, or if within the transport security layer the cipher that the backup storage system uses is disallowed. There can even be a connectivity issue with the network cable. Connectivity can be a capacity for the linking of platforms, systems, and applications.

Certificate validation is another issue if a system user set an external key manager's digital certificates valid for 1 year and the connection with the external key manager's server breaks. The dynamic security monitor 144 can detect this problem and output an alert to the system user, which identifies the issue on the validity of the digital certificates, untrusted certificates, or revocation of digital certificates on the backup storage system. Traditionally, a backup storage system detected the root cause of this issue only when a system user raised this issue.

An encryption key class may be used as an identifier by the external key manager 140 to identify a backup storage system's encryption keys. An incorrectly set up encryption key class will not fetch an encryption key, even if the encryption key exists on the external key manager 140. An encryption key class can be a set or category of a variable value that is applied using an algorithm to a string or block of uncoded text to produce coded text.

Transport security layer parameters on the external key manager 140 may be reconfigured. For example, if an Elliptic-curve Diffie-Hellman protocol cipher which was present for a transport security layer is shutdown, then even though nothing has changed on the backup storage system's side, this shutdown can still be a source of failure. A transport security layer parameter can be a numerical or other measurable factor forming a cryptographic protocol designed to provide communications free from danger and threats over a computer network. An encryption key that is present on a backup storage system might be missing, or non-existent from the external key manager 140. A non-existent encryption key can be a variable value that was applied using an algorithm to a string or block of uncoded text to produce coded text, and that is currently missing.

An external key manager assigns each encryption key to an owner who is a specific system user. An external key manager user must use their assigned encryption key while interacting with the external key manager 140. An incorrectly configured external key manager user will result in the failure of an encryption key rotation. An external key manager user can be a person responsible for controlling or administering a variable value that is applied using an algorithm to a string or block of uncoded text to produce coded text.

Following the identification of risk factors, factor scores, corresponding to the risk factors, are optionally determined based on values of the security parameters received from the backup storage system, wherein each factor score is inversely related to a corresponding level of security risk, block 206. The system can generate factor scores for the individually identified risk factors. In embodiments, this can include the dynamic security monitor 144 assigning the highest factor score of 10 to each of the risk factors which indicate that data at rest is encrypted, a security officer is configured with an appropriate level of privileges, no digital certificates are revoked, encryption keys are rotated weekly, a good connectivity with an external key manager, and a system for alerting users is enabled. However, the dynamic security monitor 144 assigns a medium-to-high-factor score of 7.5 to the risk factor for passphrases because the system user is not using sufficiently strong passphrases.

A factor score can be a number that expresses excellence by comparison to a standard influence that contributes to a result or outcome. An inverse relationship can be one in which the value of one parameter tends to decrease as the value of the other parameter increases. A security risk can be an exposure of a system to danger and threats.

The dynamic security monitor 144 assigns each risk factor a factor score that is based on a perceived risk, such as the scores ranging from the lowest factor score of 1 for a high risk, to a factor score of 5 for a medium risk, to the highest factor score of 10 for a low risk. For options which are more binary, such as whether or not a security officer authorization is enabled, the status of enabled may be assigned the highest factor score of 10 and the status of disabled may be assigned the lowest factor score of 1.

Having determined each individual factor score, a security health score is optionally determined based on each factor score, block 208. The system can combine the individual factor scores into a security health score for the backup storage system. For example, and without limitation, this can include the dynamic security monitor 144 combining all of the factors scores to generate a security health score of 75 for the system user's backup storage system. A security health score can be a number that expresses excellence by comparison to a standard for a system avoiding exposure to danger and threats.

The overall security health score may be determined using all the factor scores with their associated weights, which the dynamic security monitor 144 provides for each factor score. Based on an analysis of historical uses of factor scores that produced security health scores and subsequent security risks identified relative to each of the factor scores, determining the security health score can include determining a corresponding weight for weighing each of the factor scores. For example, some factor scores such as the factor scores for stronger non-repeating account passwords or a security officer enablement carry a heavier weight when determining the overall security health score, while other factor scores such as for the choice of an external key manager carry a lower weight when determining the overall security health score. Weights assigned to the factor scores can also change dynamically based on the features that the version control system 142 is providing to a system user in a particular software release. For example, if the version control system 142 has provided a very strong passphrase mandate for a particular software release, then the dynamic security monitor can lower the weight for the passphrase because the passphrase will have to be very strong to be accepted by the very strong passphrase mandate.

A weight can be a numerical coefficient assigned to an item to express its relative importance. An analysis can be a detailed examination of anything complex in order to understand its nature or to determine its essential features. A historical use can be a previous manner of applying something. A subsequent security risk can be a future exposure of a system to danger and threats.

A weighted average security health score=(S1*w1+S2*w2+S3*w3+ . . . +Si*wi)/(w1+w2+w3+ . . . +wi), where S1, S2, S3, . . . , Sᵢ are the scores of the factors and w1, w2, w3, . . . , wi are the weights associated with the factors, respectively. In a simplified example of calculating a weighted average security health score, factor 1 is the passphrase of the system, with a weight w1 of 9 (of a possible 10) and a score S1 of 8 (of a possible 10), factor 2 is the key rotation frequency with a weight w2 of 5 (of a possible 10) and a score S2 of 6 (of a possible 10), and factor 3 is the Transport Layer Security (TLS) version with a weight w3 of 3 (of a possible 10) and a score S3 of 7 (of a possible 10). The weighted average security health score becomes:

=([w1=9]*[S1=8])+([w2=5]*[S2=6])+([w3=3]*[S3=7])/([w1=9]+[w2=5]+[w3=3])

=(9*8)+(5*6)+(3*7)/(9+5+3)

=(72+30+21)/17

=123/17

=7.24

Normalized on scale of 1 to 100, the weighted average security health score is (7.24*10)=72.4. Continuing the example, the score S1=8 may reduce 50% to S1=4 for the factor 1 passphrase of the system. The new weighted average security health score may become:

=([w1=9]*[S1=4])+([w2=5]*[S2=6])+([w3=3]*[S3=7])/([w1=9]+[w2=5]+[w3=3])

=(9*4)+(5*6)+(3*7)/(9+5+3)

=(36+30+21)/17

=87/17

=5.12

Normalized on scale of 1 to 100, the new weighted average security health score may be (5.12*10)=51.2. As an alternative to the score S1 reducing, the score S3=7 may reduce 50% to S3=3.5 for the factor 3 TLS version. The alternative weighted average security health score may become:

=([w1=9]*[S1=8])+([w2=5]*[S2=6])+([w3=3]*[S3=3.5])/([w1=9]+[w2=5]+[w3=3])

=(9*8)+(5*6)+(3*3.5)/(9+5+3)

=(72+30)+10.5/17

=112.5/17

=6.62

Normalized on scale of 1 to 100, the alternative weighted average security health score may be (6.62*10)=66.2. This alternative example clearly indicates that reducing the score S1 of the system passphrase (factor 1 with a weight w1=9) by 50% may have a relatively large impact in reducing the resulting security health score by 29.3% from 7.24 to 5.12, while reducing the score S3 of the TLS version (factor 3 with a weight w3=3) by 50% may have a relatively small impact in reducing the resulting security health score by 8.6% from 7.24 to 6.62.

Weighing each of the factor scores may also include determining a product of each factor score to which an exponential function of a corresponding weight has been applied. For example, the weighted factor scores could be 10 [encrypted data at rest]*(10 [configured security officer] raised to the exponential power of 1.5 [enabling security officer weight])*10 [security officer appropriate privileges]*10 [no revoked digital certificates]*10 [weekly rotation of encryption keys]*(10 [external key manager connectivity] raised to the exponential power of 0.5 [external key manager weight])*10 [enabled alert system]*(7.5 [passphrases risk factor] raised to the exponential function of 2 [passwords weight]). Therefore, the factor scores and their weights could be:

=10*10\hat{ }1.5*10*10*10*10\hat{ }0.5*10*7.5\hat{ }2

=10*31.62*10*10*10*3.16*10*56.25

=562,500,000 weighted factor score.

If the factor score of 7.5 for passphrases was replaced by a maximum factor score of 10, the factor scores and their weights would be:

=10*10\hat{ }1.5*10*10*10*10\hat{ }0.5*10*10\hat{ }2

=10*31.62*10*10*10*3.16*10*100

=1,000,00,000 maximum possible weighted factor score

The security health score may be normalized by dividing 562,500,000, the weighted factor score by the maximum possible weighted factor score of 1,000,000,000 for these factors to generate a security health score of 56.25%, which may be expressed more simply as 56, which would be classified as a poor security health score. If a security officer modifies his own level of privileges to include an insecure access privilege of being a super user while working at home, and the dynamic security monitor 144 reduces the factor score for the security officer's level of privileges by 4.0 factor score points from a 10.0 factor score to a 6.0 factor score. the security health score of 56.25 may multiplied by 0.6 (6.0 divided by 10.0=0.6) to reflect the new factor adjustment of 0.6 for the security officer's level of privileges which results in a new security health score of 33.75 (56.25 multiplied by 0.6), which would be classified as an even lower poor security health score.

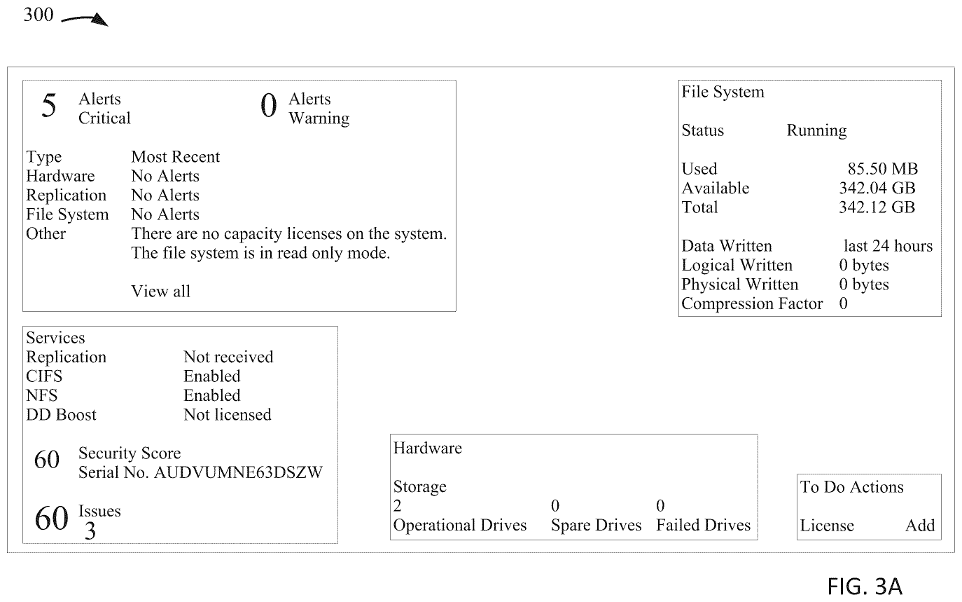

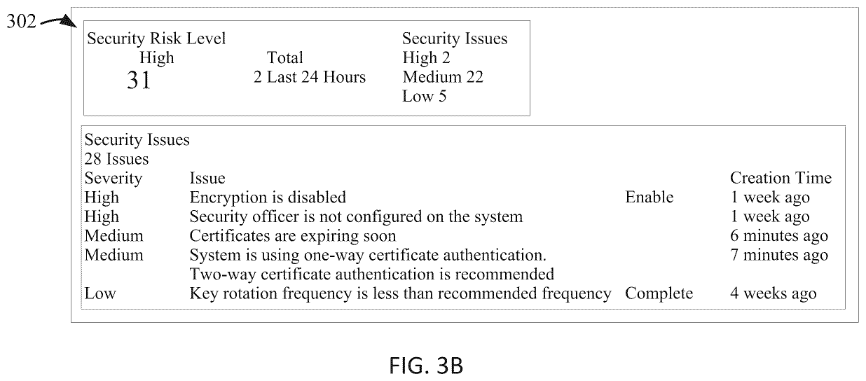

The security health score of the backup storage system may be included with the diagnosability data which was received from the backup storage system, and displayed on various management dashboards. FIG. 3A-3B are block diagrams that illustrate example manager dashboards 300-302 for a dynamic security monitor for a backup storage system, under an embodiment, in which manager dashboard 300 depicts a security health score of 60 and a list of 5 alerts that are critical, while manager dashboard 302 depicts a list of security risk factors that have risk scores which are high, medium, or low, and a list of security issues ranked by severity. Raw factor scores for all the risk factors based on security parameters help a system user to understand what security parameters have to be improved upon, and are currently contributing to a lack of security. The management dashboards can present a system user with an option to display the risk factors contributing to a less than perfect security health score.

After determining a security health score, a determination is optionally made whether the security health score is less than a threshold, block 210. The system can compare the current security health score to a standard for a healthy security score. By way of example and without limitation, this can include the dynamic security monitor 144 determining that the current security health score of 75 is less than the desired minimum security health score of 80.

If the security health score is less than a threshold, the flowchart 200 proceeds to block 212 to output an alert. If the security health score is not less than a threshold, then the flowchart 200 returns to block 202 to determine security health scores until such a score is less than the threshold. A threshold can be the magnitude or intensity that a value must be less than (or greater than) for a certain reaction, phenomenon, result, or condition to occur or be manifested.

In response to determining that the security health score is less than a threshold, an alert is optionally output to enable a system user to identify and resolve a security risk, block 212. The system can alert a system user about security risks identified by low security health scores. In embodiments, this can include the dynamic security monitor 144 alerting the system user of the need to strengthen the passphrases, as indicated by the security health score of 75. A system user can be a person who operates a computer. An alert can be an announcement or signal warning of danger.

After initially determining a security health score, the security health score is optionally updated based on any change in any value of any parameter used to determine any factor score, block 214. The system can dynamically update the security health score based on any change in any value of any parameter used to determine any factor score. For example, and without limitation, this can include the dynamic security monitor 144 responding to the system user improving the strength of the passphrases by dynamically updating the security health score to 100, and then continuing to monitor all of the values of the system parameters received in the auto-support information provided by the backup storage system used by the system user. A change can be a modification.

A security health score is optionally lowered below an additional threshold, in response to a time differential, between a previous time when an alert was output and a current time when a system user has yet to acknowledge the alert, exceeding a time threshold, block 216. The system can lower a security health score if a system user does not respond to the alert triggered by the low security health score. By way of example and without limitation, this can include the dynamic security monitor 144 responding to the system user continuing to ignore the low security health score of 75 by periodically lowering the security health score over a period of time so that this low security health score is bought to the system user's attention. In case the system user does not act upon a lower security health score, the dynamic security monitor 144 will lower the security health score further over a period of time to make the security gap more visible.

An additional threshold can be another magnitude or intensity that a value must be less than (or greater than) for a certain reaction, phenomenon, result, or condition to occur or be manifested. A time threshold can be a chronological value that a value must be less than (or greater than) for a certain reaction, phenomenon, result, or condition to occur or be manifested.

The dynamic security monitor 144 can provide three options for a system user to access the information in a file which identifies security vulnerabilities in the backup storage system used by the system user, but only vulnerabilities which have been resolved by a patch and/or an updated version of a software release, such as version 7.13 of the Data Domain operating system, which are available from the version control system 142. The dynamic security monitor 144 enables a system user to access this security vulnerabilities file, which may be structured <release version> <security issue number> <security vulnerability rank>, by selecting any one of the following options. The dynamic security monitor 144 can enable a system user to setup a subscription with the version control system 142, which will automatically push the file which lists the recently resolved security vulnerabilities to the client 102 of the system user whenever a patch or a version of a software release becomes available to be distributed. The dynamic security monitor 144 can also enable a system user to schedule a periodic query on the client 102, which at regular intervals will query the version control system 142 to list the recently resolved security vulnerabilities to the client 102 of the system user. The dynamic security monitor 144 can additionally enable a system user to manually download the file that lists the recently resolved security vulnerabilities to the client 102 of the system user, by providing the instructions for manually downloading from the version control system 142.

Therefore, the dynamic security monitor 144 can enable a system user to select from options for one of a subscription, a periodic query, or a manual download which identifies security vulnerabilities of the backup storage system which are resolved by a patch and/or a software release which are available for distribution to the backup storage system, block 218. The system enables a system user to select how to receive descriptions of the current security vulnerabilities for the system user's backup storage system which are resolved by patches and/or software releases that are available for the backup storage system. In embodiments, this can include the dynamic security monitor 144 enabling a system user to subscribe to a list of the backup storage system's recently resolved security vulnerabilities, which is provided by the version control system 142.

A subscription can be the action of agreeing to occasionally receive something. A periodic query can be a regularly recurring request for specific data from a computer. A manual download can be a human causing the copying of data from one computer system to another, typically over the internet. A security vulnerability can be a condition of being exposed to danger or a threat.

Continuing the example, the dynamic security monitor 144 considers that the system user's Data Domain operating system is on software release version 7.12 and the security health score is currently 80. In the future, when a patch 7.12.1 is available for software release version 7.12, then the dynamic security monitor 144 reduces the security health score from 80 to 78 even though the system user has not changed any setup. The reason for the score reduction is the patch version 7.12.1 has resolved security vulnerabilities present in the Data Domain operating system version 7.12, but the system user has not yet taken advantage of the opportunity to improve the security of the system user's Data Domain operating system version 7.12.

The dynamic security monitor 144 can help by resolving some issues, such as by proactively aggregating the external key-manager's health monitoring service statistics. If the digital certificates are going to expire in a few months, then the dynamic security monitor v can update a system user before the expiry takes place. The dynamic security monitor 144 can ensure that encryption key rotation is successful, thus helping with improved security of the backup storage system. Another use case is when the digital certificates have already expired, then the dynamic security monitor 144 can report this issue to a system user and suggest upgrading to new digital certificates.

The dynamic security monitor 144 can detect if a digital certificate is revoked. In case of connectivity issues, the dynamic security monitor 144 can periodically evaluate the connectivity to the external key manager's server and then report the connectivity issues to a system user before the system user needs to connect their backup storage system. The dynamic security monitor 144 can detect if a valid read-write key is present with the associated key class. The dynamic security monitor 144 can also detect if the transport security layer parameters are reconfigured on a backup storage's server side and if they are the cause of an encryption key rotation failure, and then report this information to a system user.

The dynamic security monitor 144 can alert a system user beforehand about the security vulnerabilities. The dynamic security monitor 144 can schedule a periodic run to determine the above issues for a backup storage system. A major advantage of this scheduling is that the dynamic security monitor 144 can report the problem and solution to a system user even before any problem occurs.

Although FIG. 2 depicts the blocks 202-218 occurring in a specific order, the blocks 202-218 may occur in another order. In other implementations, each of the blocks 202-218 may also be executed in combination with other blocks and/or some blocks may be divided into a different group of blocks.

FIG. 4 is a flowchart 400 that illustrates a method for dynamic security monitoring of user activities in networked backup storage systems, in an embodiment. Flowchart 400 depicts method acts illustrated as flowchart blocks for certain steps involving the client 102, the backup storage systems 114-118, and the dynamic security monitor 144 of FIG. 1.

Machine-learning models are trained to identify historical activities, performed by users of backup storage systems, which include atypical activities and/or resemblances to malicious activities, block 402. The system trains machine-learning models to recognize user activities that consist of atypical activities and/or resemblances to malicious activities. For example, and without limitation, this can include the backup server 106 training the machine-learning models 146 to identify when Acme employees accessed data from any of Acme's backup storage system in networked backup storage systems 114-118 in unusual ways and to identify various malware attacks on any of Acme's backup storage systems 114-118.

A machine-learning model can be an application of artificial intelligence that provides a system with the ability to automatically learn and improve from experience without being explicitly programmed. An activity can be busy or vigorous actions. A historical activity can be busy or vigorous actions that occurred in the past.

A user can be a human or an application that operates a computer. An atypical activity can be busy or vigorous actions which occur infrequently. A resemblance can be a similarity without necessarily being required to be identical. A malicious activity can be busy or vigorous actions that are intended to do harm.

Identification of atypical activities may be based on an amount of data which is accessed by a user and/or an application, an amount of data files transferred by the user and/or the application, a time and/or a location for a login by the user, a command for storing a passphrase for a system onto a disk, and/or a command for deleting at least a part of a file system, a cloud storage, and/or a Merkle tree. For example, if an Acme employee or an Acme application had significantly increased the amount of data accessed, or the application had significantly increased the amount of data files transferred, or if the Acme employee had commanded the deletion of at least a part of the file system, cloud storage, and/or Merkle tree, then the machine-learning models 146 would have identified these activities as unusual.

An amount can be a quantity of something, especially the total of things in number. Data can be information that may be used and interpreted by computers. An application can be a computer software package that performs a specific function for an end user. A data file can be an object on a computer that stores information used with a computer program. A location can be any place in computer memory in which an item of data—usually a word or byte—may be stored in binary form.

A login can be the process by which an individual gains access to a computer system. A command can be a directive to a computer program to perform a specific task. A system can be a set of integrated devices that input, output, process, and store data and information. A disk can be an information storage device for a computer.

A part can be some but not all of something. A file system can be a structure used by an operating system to organize and manage objects in a computer. A cloud storage can be a computer element which retains data for a user, and which is available on-demand without direct active management by the user. A Merkle tree can be a data structure in which every leaf node is labelled with the cryptographic hash of a data block.

Malware detection software can use static analysis techniques and/or dynamic analysis techniques to detect malware. Static analysis involves studying the software code of a potentially malicious program and producing a signature of that program. This information is then used to compare scanned files by an antivirus program. Because this approach is not useful for malware that has not yet been studied, malware detection software can use dynamic analysis to monitor how a program runs on a computer and block the program if the program performs unexpected activities.

The identification of activities which resemble malicious activities may be based on 1) a data file that has similarities to a signature and/or an attack pattern of an instance of malware, 2) data which is from network traffic and/or a system log, and/or 3) a header, content, and/or user behavior that is associated with an email and has similarities to a phishing email, such as content that prompts unusual selection behavior from readers of the email. For example, if a malware virus had a recognized signature, even if neither the malware's attack pattern, nor the malware's network traffic patterns had been fully recognized yet, the machine-learning models 146 would have identified these malware activities as malicious activities. In another example, the machine-learning models 146 may use natural language processing models to analyze an email's header and/or text to identify suspicious language and/or uniform resource locators (URLs), while behavioral analysis can identify unusual clicking behavior by Acme employees, either of which would identify these employees as victims of a cyber-crime, specifically phishing.

A signature can be an authentication mechanism that enables a message's creator to attach code that acts as an identifier of the message. An attack pattern can be the tactics, techniques, and procedures that describe the methods that adversaries use in attempts to compromise targets. An instance can be an example or single occurrence of something. Malware can be software that is specifically designed to disrupt, damage, or gain unauthorized access to a computer system.

Network traffic can be the data moving across a computer system at any given time. A system log can be a record of software and hardware events that occurred on a computer. A header can be the part of an email before the message, containing information such as the subject and the sender. Content can be information made available by a website or other electronic medium.

User behavior can be the way in which a person interacts with a computer. An email can be messages distributed by electronic means from one computer user to one or more recipients via a network. A phishing email can be an attempt to acquire sensitive information directly from users by deceiving the users via messages distributed by electronic means in a computer network.

After being trained, machine-learning models identify activities, performed by a user of a backup storage system, which include any atypical activities or resemble any malicious activities, block 404. The system uses machine-learning models to analyze backup storage system activities to identify atypical activities and malicious activities. By way of example and without limitation, this can include the trained machine-learning models 146 identifying the amounts of data accessed, the rates of data accessed, and the transferring of files as slightly usual activities for a specific Acme employee, and failing to recognize any malware signatures or attack patterns in the backup storage system.

However, since the Acme employee had almost always logged into Acme's backup storage system from his desk at Acme headquarters during normal business hours, the machine-learning models 146 identify the Acme employee apparently logging into the backup storage system from a location outside of work as an unusual activity, and logging in at midnight on a Saturday as also an unusual activity. The machine-learning models 146 also identify the Acme employee's commands to significantly increase the amounts of files transferred as slightly resembling many ransomware attacks which transfer large amounts of files within backup storage systems before encrypting the data in the files and then transferring the encrypted data files back to their previous storage locations within the backup storage system. Some can be an unspecified amount or number of a thing.

Following the identification of activities, taken by any user of a backup storage system, as consisting of atypical activities and/or resembling malicious activities, activity scores are determined corresponding to the identified activities, wherein each activity score is related to a corresponding level of security risk, block 406. The system determines activity scores for the activities which are identified as atypical activities and/or malicious activities. In embodiments, this can include the dynamic security monitor 144 assigning an activity score of 9 and a weight of 4 to the data accessed rates, a score of 9 and a weight of 4 to the data accessed amounts, a score of 9 and a weight of 2 to the data transfer command, a score of 8 and a weight of 4 to the login time, a score of 8 and a weight of 8 to the login location, and a score of 7 and a weight of 10 to the data files transferred.

The dynamic security monitor 144 assigns each activity to an activity score that is based on a perceived risk, such as the scores ranging from the lowest activity score of 1 for a high risk, to an activity score of 5 for a medium risk, to the highest activity score of 10 for a low risk. Although examples in this disclosure describe activity scores which are based on integers, such as the activity scores which range from 1 to 10, activity scores may be any range of any type of numbers, such as negative 3.14159 to positive 3.14159.

Alternatively, the Acme employee may usually transfer the amount of data files at the rate observed, and the security heath score may be based on a product of the activity scores which have been raised by the power of their corresponding weights. In this combination of situations, the dynamic security monitor 144 can assign activity scores of 10 to each of the usual amounts of data accessed, the usual rates of data accessed, and the usual transfer of files, activity scores of 9 for each of the unusual login time and the unusual login location, and an activity score of 8 for the Acme employee's commands to significantly increase the amount of data files transferred, which slightly resembles many ransomware attacks which transfer large amounts of data files within a backup storage system before encrypting the data in the files, and then transferring the encrypted data files back to their previous storage locations within the backup storage system.

Continuing the alternative example, the dynamic security monitor 144 can also assign exponential weights to each of the activity scores, such as assigning the heaviest weight of 2 to the activity score for commands to significantly increase the amount of data files transferred, assigning a heavy weight of 1.5 to the activity score for unusual logon location, assigning a low weight of 0.5 to the activity score for the usual command to transfer a data file, and assigning a neutral weight of 1.0 to all remaining activity scores. Although examples in this disclosure describe activity score weights which are based on integers or halves of integers, such as the weights of 0.5, 1.5, and 2, activity score weights may be any range of any type of numbers, such as negative 3.14159 to positive 3.14159.

Having determined each individual activity score, a security health score is output based on each activity score, block 408. The system combines the individual activity scores into a security health score for a backup storage system. Outputting the security health score may include weighing each of the activity scores by a corresponding weight which is determined based on an analysis of historical uses of activity scores to produce security health scores for subsequent security risks identified relative to each of the activity scores, wherein weighing each of the activity scores includes, determining a sum of each product of each activity score and a corresponding weight, or determining a product of each activity score to which an exponential function of a corresponding weight has been applied.

For example, some activity scores, such as the activity scores for storing a system passphrase on a disk, carry a heavier weight when determining the overall security health score. In contrast, other activity scores, such as the activity scores for a significant increase in the amount of data accessed, may be assigned a lower weight when determining the overall security health score because system users may have many legitimate reasons for increasing the amount of data typically accessed, whereas storing a system passphrase on a disk is seldom done, and this activity may be a frequent goal for malware attacks. Weights assigned to the activity scores can change dynamically. A product can be the number or expression resulting from the multiplication together of two or more numbers or expressions. An exponential function can be a mathematical process which raises a constant value to the power of an argument.

For example, and without limitation, this can include the dynamic security monitor 144 determining that the activity scores and their corresponding activity score weights are (data accessed rates: score of 9*weight of 4)+(data accessed amounts: score of 9*weight of 4)+(data transfer command: score of 9*weight of 2)+(login time: score of 8*weight of 4)+(login location: score of 8*weight of 8)+(data files transferred: score of 7*weight of 10)/[weights of 4+4+2+4+8+10). Therefore, the dynamic security monitor 144 determines that the activity scores and their corresponding activity score weights become:

=(9*4)+(9*4)+(9*2)+(8*4)+(8*8)+(7*10)/(4+4+2+4+8+10)

=(36+36+18+32+64+70)/(32)

=256/32

=8

The score of 8 can be normalized by multiplying by 10 to become 80, which is the threshold where a good security health score becomes a fair security health score. A sum can be the total amount resulting from the addition of two or more numbers, amounts, or items.

In the alternative example, the dynamic security monitor 144 determines that the activity scores and their corresponding activity score weights become 10 [usual amounts of data accessed]*10 [usual rates of data accessed]*(exponential function of 0.5 [weight of command for data file transfer] applied to 10 [usual command to transfer a data file])*(9 [unusual login time])*(exponential function of 1.5 [weight of command for unusual login location] applied to 9 [unusual login location])*(exponential function of 2 [weight of command for data file transfer] applied to 8 [significant increase in data files transferred]). In this example, if an exponential function is not explicitly applied to an activity score, then a neutral exponential function of 1.0 is implicitly applied to the activity score. Therefore, the dynamic security monitor 144 determines that the activity scores and their corresponding activity score weights become:

=(10\hat{ }1)*(10\hat{ }1)*(10\hat{ }0.5)*(9\hat{ }1)*(9\hat{ }1.5)*(8\hat{ }2)

=10*10*3.16*9*27*64

=4,917,974.2

If the activity scores of 9, 9, and 8 are each replaced by a maximum activity score of 10, the maximum possible activity scores and their corresponding activity score weights become:

=(10\hat{ }1)*(10\hat{ }1)*(10\hat{ }−0.5)*(10\hat{ }1)*(10\hat{ }1.5)*(10\hat{ }2)

=10*10*3.16*10*31.6*100

=10,000,000

Then the dynamic security monitor 144 generates a normalized security health score by dividing the product of the weighted activity scores of 4,917,974.2 by the product of the maximum possible weighted activity scores of 10,000,000 for these activity scores to generate a normalized security health score of 0.4917, which may be expressed more simply as 49.2% or 49, which is classified as a poor security health score.

Although these examples above are based on a combination of identified activities resulting in generating a security health score which falls below specific alert thresholds and trigger alerts when the individually identified activities would not have triggered the same alert, the machine-learning models 146 are fully cable of identifying a single activity that can result in an individual activity score which can trigger any alert. For example, if instead of the unusual login time for an employee which occurs on midnight on a Saturday night, the unusual login time for an employee which occurs 5 minutes after the employee was terminated can result in an activity score that would independently fall below a threshold which trigger an alert. In another example, if instead of the unusual login location for an employee being away from the office at a location identified as the employee's house, the unusual login location of North Korea would result in an activity score that is below a threshold which can independently trigger an alert. In yet another example, if instead of the employee significantly increasing the amount of data files transferred, the activity which resembled malware activities was the employee significantly increasing the number of commands deleting parts of the file system would result in an activity score that is below a threshold which would independently trigger an alert.

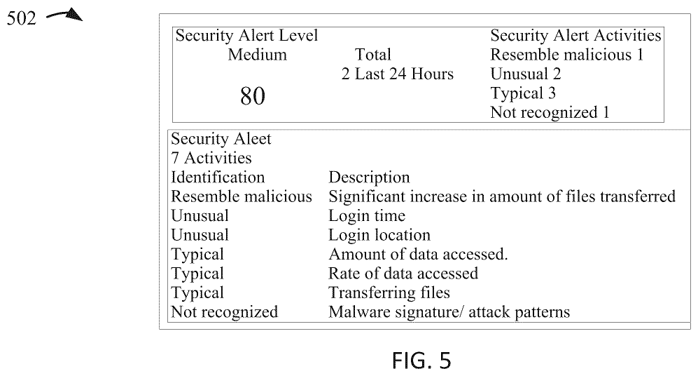

FIG. 5 depicts a block diagram that illustrates an example manager dashboard 502 for the dynamic security monitor 144 for networked backup storage system, under an embodiment. The manager dashboard 502 depicts a security health score of 80 that triggered an alert, the 2 hours and 24 minutes duration of the alert, and the number of activities that were identified for each type of issue for the alert. For example, the security health score of 80 triggered a medium alert based on 1 activity that is identified as resemble malicious, 2 activities that are identified as unusual, 3 activities that are identified as typical, and 1 activity that is identified as not recognized. The management dashboard 502 can present a system administrator with an option to display the details for each of the activities which were identified for generating the security health score, which can include the lack of identifying malware, which did not result in the identification of any issues, and the identification of activities as typical which also did not identify any issue.

The management dashboard 502 can present a system administrator with an option to display only the activities which identified any issues for the alert. Based on the previous configuration or the current selection of options by a system administrator, manager dashboard 502 depicts a list of identifying 1 activity that resembles a malicious activity, which is the significant increase in the amount of files transferred, and the 2 activities that are identified as unusual, which are the login time and the login location. The optional list also includes the 3 activities that are identified as typical, which includes the amount of the data accessed, the rate of the data accessed, and the command for transferring files, and the 1 activity which was not recognized, which is the malware signature and attack patterns. The option of displaying the raw activity scores for all the identified activities may be selected to help a system administrator to understand what activities do and do not need to be addressed.

After determining a security health score, a determination is made whether the security health score is less than a threshold, block 410. The system compares the current security health score to a standard for a healthy security score. By way of example and without limitation, this can include the dynamic security monitor 144 determining that the current security health score of 80 is less than the fair security health threshold of greater than 80. If the security health score is less than a threshold, the flowchart 400 proceeds to block 412 to isolate the backup storage system and enable another backup storage system to output another security health score based on at least one of the activity scores associated with the backup storage system. If the security health score is not less than a threshold, then the flowchart returns to block 402 to determine security health scores until such a score is less than the threshold.

In response to determining that a security health score is less than a threshold, a backup storage system is isolated and another backup storage system is enabled to output another security health score based on one of the activity scores associated with the backup storage system, block 412. The system identifies and isolates the activity in the backup storage system that is most responsible for triggering the alert, which increases the sensitivity of other backup storage systems to detect the same type of activity that was most responsible for triggering the alert. The other security health score being based on one of the activity scores associated with the backup storage system may include adjusting at least one of a weight corresponding to another activity score that is associated with the other backup storage system and which corresponds to the activity score, or a relationship between the other security health score and a corresponding threshold. In embodiments, this can include the dynamic security monitor 144 enabling the other backup storage systems in the network to be more sensitive to the probability of a similar security alert by temporarily reducing the activity score, such as reducing 10% from a 10 to a 9 for the data files transferred, by temporarily increasing the weight of the activity score, such as increasing by 50% from 2 to 3 for the data files transferred, and/or by temporarily raising the fair security health threshold, such as by 6.25% from 80 to 85, or the poor security health threshold, such as by 16.66% from 60 to 70, for the data files transferred, in each of the networked backup storage systems. A relationship can be the way in which two or more concepts or objects are connected, or the state of being connected.

Even though none of the individual activity scores was low enough to individually trigger the alert threshold, collectively the activity scores produced a security health score of 80 that is low enough to trigger the fair security health threshold which requires being above 80. Since the security health score of 80 is less than the fair security health threshold of above 80, the dynamic security monitor enables other backup storage systems in the network to output their own security health scores based on at least the activity score which was most responsible for the security health score falling below the good security health threshold, such as the activity score of 7 [significant increase in data files transferred].

In the alternative example, even though none of the individual activity scores was low enough to individually trigger the poor security health alert threshold, collectively the activity scores produced a security health score of 49 that is low enough to trigger the poor security health threshold of 60. Since the security health score of 49 is less than the poor security health threshold of 60, the dynamic security monitor enables other backup storage systems in the network to output their own security health scores based on at least the activity score which was most responsible for the security health score falling below the fair security health threshold, such as the activity score of 8 [significant increase in data files transferred].

When the dynamic security monitor 144 enables other backup storage systems to generate their own security health scores based on at least one of the activity scores which contributed to the alert identified by the backup storage system, then the other dynamic security monitors for the other backup storage systems can prepare to output their security heath score as a product of the activity scores increased exponentially by their weights or a sum of the activity scores which have been multiplied by heir weights. Therefore, examples of the corresponding activity scores and their activity scores weights can include data accessed rates: score of 10*weight of 4)+(data accessed amounts: score of 10*weight of 4)+(data transfer command: score of 10*weight of 2)+(login time: score of 9*weight of 4)+(login location: score of 9*weight of 8)+(data files transferred: score of 8*weight of 10)/[weights of 4+4+2+4+8+10). Consequently, the activity scores and their weights can be:

=(10*4)+(10*4)+(10*2)+(9*4)+(9*8)+(8*10)/(4+4+2+4+8+10)

=(40+40+20+36+72+80)/(32)

=288/32

=9

Each of the other backup storage systems' dynamic security monitors can normalize the score of 9 by multiplying by 10 to become a goof security health score of 90. Whereas before the dynamic security monitor 144 identified an alert in the first backup data storage system, the remainder of the backup storage systems connected by a network potentially had security health scores of 100 which were 20 above triggering fair security health thresholds of 80. However, after the first backup storage system generated the security alert, the first backup storage system alerted the remaining backup storage systems in the network, which calculated their security health scores of 90, which are only 5 above triggering the adjusted fair security health thresholds of 85, which therefore have a heighted sensitivity for detecting the user activities which resulted in generating a security alert which was identified by the first backup storage system.

Alternatively, examples of the corresponding activity scores and their activity scores weights can include 10 [usual amounts of data accessed]*10 [usual rates of data accessed]*(exponential function of 0.5 [weight of command for data file transfer] applied to 10 [usual command to transfer a data file])*(10 [unusual login time])*(exponential function of 1.5 [weight of command for unusual login location] applied to 10 [usual login location])*(exponential function of 3 [weight of command for data file transfer] applied to 9.5 [anticipated increase in data files transferred]). Therefore, the activity scores and their weights are

=(10\hat{ }1)*(10\hat{ }1)*(10\hat{ }0.5)*(10\hat{ }1)*(10\hat{ }1.5)*(9\hat{ }3)

=10*10*3.16*10*31.62*857.375

=85,737,500.

If the activity score of 9.5 is replaced by a maximum activity score of 10, the product of the maximum possible activity scores and their weights is:

\hat{ }(10\hat{ }1)*(10\hat{ }1)*(10\hat{ }0.5)*(10\hat{ }1)*(10\hat{ }1.5)*(10\hat{ }3)

=10*10*3.16*10*31.62*1,000

=100,000,000.

Each of the other backup storage systems' dynamic security monitors can normalize a security health score by dividing the product of the activity scores of 85,737,500 by the product of the maximum possible activity scores of 100,000,000 to generate a normalized security health score of 85.7%, which may be expressed more simply as 85. Whereas before the dynamic security monitor 144 identified an alert in the first backup data storage system, the remainder of the backup storage systems connected by a network potentially had security health scores of 100 which were 40 above triggering poor security health thresholds. However, after the first backup storage system generated the security alert, the first backup storage system alerted the remaining backup storage systems in the network, which calculated their security health scores of 85, which are only 15 above triggering the adjusted poor security health thresholds of 70, which therefore have a heighted sensitivity for detecting the user activities which resulted in generating a security alert which was identified by the first backup storage system.

Continuing this example, all the other activity scores and weights remain the same when a security officer modifies his own level of privileges to include an insecure access privilege of being a super user while working at home, and the dynamic security monitor 144 changes the activity score for the security officer's level of privileges from a 10.0 to a 6.0. This change of a single parameter can result in multiplying the previous product by 0.6 (the current activity score of 6.0 for the security officer's level of privileges divided by the previous activity score of 10.0 for the security officer's level of privileges equals 0.6), which drastically reduces the security health score from 49 to 29, which remains classified as poor.

Isolating a backup storage system may include 1) disabling network access, 2) implementing a firewall rule, 3) blocking a suspicious process, or 4) outputting an alert which enables a system administrator to identify and resolve a security alert. For example, the dynamic security monitor 144 blocks a suspicious process, such as a file deletion command, on Acme's backup storage system, and outputs an alert which enables an Acme system administrator to identify and resolve the security alert created by the Acme employee remotely accessing the Acme backup storage system at midnight Saturday and transferring files.

Network access can be communication by a process or a user within a system of connected computers. A firewall rule can be a specification how to handle network traffic to help protect a network from unauthorized access and harmful applications. A suspicious process can be unusual behavior exhibited by a software program executing in a system.

A cloud storage can be a mode of computer data retention in which digital data is maintained on servers in off-site locations. A system administrator can be a person who manages the operation of a computer or particular electronic communication service.

The dynamic security monitor 144 takes care to minimize false positives to avoid unnecessary disruptions to legitimate operations within the network. If the dynamic security monitor 144 determines that a security alert that was generated by one of the backup storage systems in the network was a false positive, such that the security health score which was below a threshold was based on activity scores which did not actually identify a security threat, then the dynamic security monitor 144 can inform the automated response system to reverse the effects of the security alert for each of the other backup storage systems in the network. For example, a team of system administrators determine that the Acme employee logging into the backup storage system from his house at midnight on a Saturday and executing commands to significantly increase the amounts of files transferred caused a security alert because the employee's supervisor incorrectly submitted the authorization for the employee to work on this weekend project at home. In response to this updated information from the dynamic security monitor 144, the automated response system reverses the effects of the security alert by raising the activity score for the data files transferred by 10%, from a 9 to a 10, by decreasing the weight of the data files transferred score by 33%, from 3 to 2, and/or by reducing the poor security health threshold for each of the networked backup storage systems by 14.28, from 70 to 60.

After initially determining a security health score, the security health score is updated based on any change to any identified activity, block 414. The system dynamically updates the security health score based on any change in any activity used to determine any activity score. For example, and without limitation, this can include the dynamic security monitor 144 following the resolution of the security alert caused by the Acme employee by outputting an updated security health score of 100 based on the improvement in the activities used to assign the activity scores for the user login time, the user login location, and the Acme employee's at least temporarily paused use of transfer commands. Then the dynamic security monitor 144 continues to monitor all of the activities when Acme employees access data from Acme's backup storage system in unusual ways and various malware attacks on Acme's backup storage system.

A security health score is optionally lowered below an additional threshold, in response to a time differential, between a previous time when an alert was output and a current time when a system administrator has yet to acknowledge the alert, exceeding a time threshold, block 416. The system lowers a security health score if a system administrator does not respond to the alert triggered by the low security health score. By way of example and without limitation, this can include the dynamic security monitor 144 responding to the Acme system administrator continuing to ignore the fair security health score of 80 by periodically lowering the security health score over a period of time so that this low security health score is bought to the system administrator's attention. In case the system administrator does not act upon a lower security health score, the dynamic security monitor 144 will lower the security health score further over a period of time to make the security gap more visible.

The dynamic security monitor 144 can provide three options for a system administrator to access the information in a file which identifies security vulnerabilities in the backup storage system used by the system administrator, but only vulnerabilities which have been resolved by a patch and/or an updated version of a software release, such as version 7.13 of the Data Domain operating system, which are available from the version control system 142. The dynamic security monitor 144 enables a system administrator to access this security vulnerabilities file, which may be structured <release version> <security issue number> <security vulnerability rank>, by selecting any one of the following options. The dynamic security monitor 144 can enable a system administrator to setup a subscription with the version control system 142, which will automatically push the file which lists the recently resolved security vulnerabilities to the client 102 of the system administrator whenever a patch or a version of a software release becomes available to be distributed. The dynamic security monitor 144 can also enable a system administrator to schedule a periodic query on the client 102, which at regular intervals will query the version control system 142 to list the recently resolved security vulnerabilities to the client 102 of the system administrator. The dynamic security monitor 144 can additionally enable a system administrator to manually download the file that lists the recently resolved security vulnerabilities to the client 102 of the system administrator, by providing the instructions for manually downloading from the version control system 142.

Therefore, the dynamic security monitor can enable a system administrator to select from options for a subscription, a periodic query, and/or a manual download which identifies security vulnerabilities of the backup storage system which are resolved by a patch and/or a software release which are available for distribution to the backup storage system, block 418. The system enables a system administrator to select how to receive descriptions of the current security vulnerabilities for the system administrator's backup storage system which are resolved by patches and/or software releases that are available for the backup storage system. In embodiments, this can include the dynamic security monitor 144 enabling a system administrator to subscribe to a list of the backup storage system's recently resolved security vulnerabilities, which is provided by the version control system 142.

Continuing the example, the dynamic security monitor 144 considers that the system administrator's Data Domain operating system is on software release version 7.12 and the security health score is currently 80. In the future, when a patch 7.12.1 is available for software release version 7.12, then the dynamic security monitor 144 reduces the security health score from 80 to 78 even though the system administrator has not changed any setup. The reason for the score reduction is the patch version 7.12.1 has resolved security vulnerabilities present in the Data Domain operating system version 7.12, but the system administrator has not yet taken advantage of the opportunity to improve the security of the system administrator's Data Domain operating system version 7.12.

Although FIG. 4 depicts the blocks 402-418 occurring in a specific order, the blocks 402-418 may occur in another order. In other implementations, each of the blocks 402-418 may also be executed in combination with other blocks and/or some blocks may be divided into a different group of blocks.

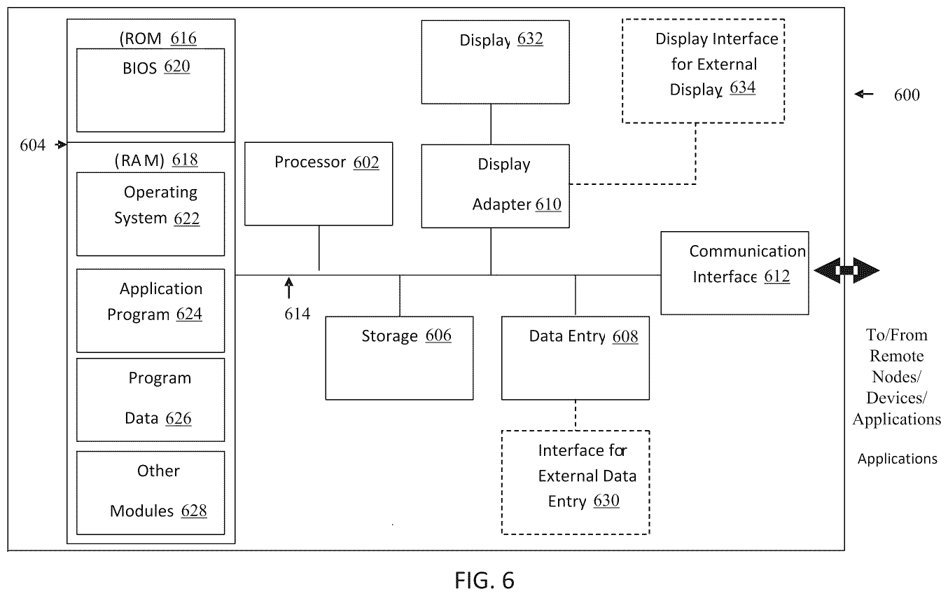

Having described the subject matter in detail, an exemplary hardware device in which the subject matter may be implemented shall be described. Those of ordinary skill in the art will appreciate that the elements illustrated in FIG. 6 may vary depending on the system implementation. With reference to FIG. 6, an exemplary system for implementing the subject matter disclosed herein includes a hardware device 600, including a processing unit 602, memory 604, storage 606, a data entry module 608, a display adapter 610, a communication interface 612, and a bus 614 that couples the elements 604-612 to the processing unit 602.

The bus 614 may comprise any type of bus architecture. Examples include a memory bus, a peripheral bus, a local bus, etc. The processing unit 602 is an instruction execution machine, apparatus, or device and may comprise a microprocessor, a digital signal processor, a graphics processing unit, an application specific integrated circuit (ASIC), a field programmable gate array (FPGA), etc. The processing unit 602 may be configured to execute program instructions stored in the memory 604 and/or the storage 606 and/or received via the data entry module 608.

The memory 604 may include read only memory (ROM) 616 and random-access memory (RAM) 618. The memory 604 may be configured to store program instructions and data during operation of the hardware device 600. In various embodiments, the memory 604 may include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 604 may also include nonvolatile memory technologies such as nonvolatile flash RAM (NVRAM) or ROM. In some embodiments, it is contemplated that the memory 604 may include a combination of technologies such as the foregoing, as well as other technologies not specifically mentioned. When the subject matter is implemented in a computer system, a basic input/output system (BIOS) 620, containing the basic routines that help to transfer information between elements within the computer system, such as during start-up, is stored in the ROM 616.

The storage 606 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD, or other optical media. The drives and their associated computer-readable media provide nonvolatile storage of computer readable instructions, data structures, program modules and other data for the hardware device 600. It is noted that the methods described herein may be embodied in executable instructions stored in a computer readable medium for use by or in connection with an instruction execution machine, apparatus, or device, such as a computer-based or processor-containing machine, apparatus, or device.

It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for conducting the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 606, the ROM 616 or the RAM 618, including an operating system 622, one or more applications programs 624, program data 626, and other program modules 628. A user may enter commands and information into the hardware device 600 through the data entry module 608. The data entry module 608 may include mechanisms such as a keyboard, a touch screen, a pointing device, etc. Other external input devices (not shown) are connected to the hardware device 600 via an external data entry interface 630.

By way of example and not limitation, external input devices may include a microphone, joystick, game pad, satellite dish, scanner, or the like. In some embodiments, external input devices may include video or audio input devices such as a video camera, a still camera, etc. The data entry module 608 may be configured to receive input from one or more users of the hardware device 600 and to deliver such input to the processing unit 602 and/or the memory 604 via the bus 614.

A display 632 is also connected to the bus 614 via the display adapter 610. The display 632 may be configured to display output of the hardware device 600 to one or more users. In some embodiments, a given device such as a touch screen, for example, may function as both the data entry module 608 and the display 632. External display devices may also be connected to the bus 614 via an external display interface 634. Other peripheral output devices, not shown, such as speakers and printers, may be connected to the hardware device 600.

The hardware device 600 may operate in a networked environment using logical connections to one or more remote nodes (not shown) via the communication interface 612. The remote node may be another computer, a server, a router, a peer device, or other common network node, and typically includes many or all the elements described above relative to the hardware device 600. The communication interface 612 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 612 may include logic configured to support direct memory access (DMA) transfers between the memory 604 and other devices.

In a networked environment, program modules depicted relative to the hardware device 600, or portions thereof, may be stored in a remote storage device, such as, for example, on a server. It will be appreciated if other hardware and/or software to establish communications between the hardware device 600 and other devices may be used.

The arrangement of the hardware device 600 illustrated in FIG. 6 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 600.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 6.

Other components may be implemented in software, hardware, or a combination of software and hardware. Moreover, some or all these other components may be combined, some may be omitted altogether, and additional components may be added while still achieving the functionality described herein. Thus, the subject matter described herein may be embodied in many different variations, and all such variations are contemplated to be within the scope of what is claimed.

In the description herein, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data for maintains it.

The computer, which reconfigures or otherwise alters the operation of the device in a manner well understood by those skilled in the art. The data structures where data is maintained are physical locations of the memory that have properties defined by the format of the data. However, while the subject matter is described in this context, it is not meant to be limiting as those of skill in the art will appreciate that various of the acts and operations described herein may also be implemented in hardware.

To facilitate an understanding of the subject matter described, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A system for dynamic security monitoring of user activities in networked backup storage systems, comprising:
one or more processors; and
a non-transitory computer readable medium storing a plurality of instructions, which when executed, cause the one or more processors to:
train machine-learning models to identify historical activities, performed by users of backup storage systems, which comprise at least one of atypical activities or resemblances to malicious activities;
identify, by the machine-learning models, activities, performed by any user of a backup storage system, which comprise at least one of any of the atypical activities or a resemblance to any of the malicious activities;
determine activity scores, corresponding to the identified activities, wherein each activity score is related to a corresponding level of security risk;
output a security health score based on the activity scores;
isolate the backup storage system and enable another backup storage system to output another security health score based on one of the activity scores associated with the backup storage system, in response to a determination that the security health score is less than a threshold; and
output an updated security health score based on any change to any identified activity.

2. The system of claim 1, wherein identifying the activities is based on one or more of the following: 1) one of an amount of data which is accessed or an amount of data files transferred by one of a system user or an application that functions as a user, 2) at least one of a time or a location for a login by the system user, 3) a command for storing a passphrase for a system onto a disk, 4) a command for deleting at least a part of one of a file system, a cloud storage, or a Merkle tree, 5) a data file that has similarities to at least one of a signature or an attack pattern for an instance of malware, 6) data which is from at least one of network traffic or a system log, or 7) at least one of a header, content, or user behavior that is associated with an email and has similarities to a phishing email.

3. The system of claim 1, wherein outputting the security health score comprises weighing each of the activity scores by a corresponding weight which is determined based on an analysis of historical uses of activity scores to produce security health scores and subsequent security risks identified relative to each of the activity scores, wherein weighing each of the activity scores comprises at least one of determining a sum of each product of each activity score and a corresponding weight, or determining a product of each activity score to which an exponential function of a corresponding weight has been applied.

4. The system of claim 1, wherein isolating the backup storage system comprises at least one of 1) disabling network access, 2) implementing a firewall rule, 3) blocking a suspicious process, or 4) outputting an alert which enables a system administrator to identify and resolve a security risk.

5. The system of claim 1, wherein the other security health score being based on one of the activity scores associated with the backup storage system comprises adjusting at least one of a weight corresponding to another activity score that is associated with the other backup storage system and which corresponds to the activity score, or a relationship between the other security health score and a corresponding threshold.

6. The system of claim 1, wherein the plurality of instructions further causes the processor to lower the security health score below an additional threshold, in response to a time differential, between a previous time when the alert was output and a current time when a system administrator has yet to acknowledge the alert, exceeding a time threshold.

7. The system of claim 1, wherein the plurality of instructions further causes the processor to enable a system administrator to select an option associated with one of a subscription, a periodic query, or a manual download to identify any security vulnerability of the backup storage system which is resolved by at least one of a patch or a software release which is available for distribution to the backup storage system.

8. A computer-implemented method for dynamic security monitoring of user activities in networked backup storage systems, the computer-implemented method comprising:
training machine-learning models to identify historical activities, performed by users of backup storage systems, which comprise at least one of atypical activities or resemblances to malicious activities;
identifying, by the machine-learning models, activities, performed by any user of a backup storage system, which comprise at least one of any of the atypical activities or a resemblance to any of the malicious activities;
determining activity scores, corresponding to the identified activities, wherein each activity score is related to a corresponding level of security risk;
outputting a security health score based on the activity scores;
isolating the backup storage system and enabling another backup storage system to output another security health score based on one of the activity scores associated with the backup storage system, in response to a determination that the security health score is less than a threshold; and
outputting an updated security health score based on any change to any identified activity.

9. The computer-implemented method of claim 8, wherein identifying the activities is based on one or more of the following: 1) one of an amount of data which is accessed or an amount of data files transferred by one of a system user or an application that functions as a user, 2) at least one of a time or a location for a login by the system user, 3) a command for storing a passphrase for a system onto a disk, 4) a command for deleting at least a part of one of a file system, a cloud storage, or a Merkle tree, 5) a data file that has similarities to at least one of a signature or an attack pattern for an instance of malware, 6) data which is from at least one of network traffic or a system log, or 7) at least one of a header, content, or user behavior that is associated with an email and has similarities to a phishing email.

10. The computer-implemented method of claim 8, wherein outputting the security health score comprises weighing each of the activity scores by a corresponding weight which is determined based on an analysis of historical uses of activity scores to produce security health scores and subsequent security risks identified relative to each of the activity scores, wherein weighing each of the activity scores comprises at least one of determining a sum of each product of each activity score and a corresponding weight, or determining a product of each activity score to which an exponential function of a corresponding weight has been applied.

11. The computer-implemented method of claim 8, wherein isolating the backup storage system comprises at least one of 1) disabling network access, 2) implementing a firewall rule, 3) blocking a suspicious process, or 4) outputting an alert which enables a system administrator to identify and resolve a security risk.

12. The computer-implemented method of claim 8, wherein the other security health score being based on one of the activity scores associated with the backup storage system comprises adjusting at least one of a weight corresponding to another activity score that is associated with the other backup storage system and which corresponds to the activity score, or a relationship between the other security health score and a corresponding threshold.

13. The computer-implemented method of claim 8, wherein the computer-implemented method further comprises lowering the security health score below an additional threshold, in response to a time differential, between a previous time when the alert was output and a current time when a system administrator has yet to acknowledge the alert, exceeding a time threshold.

14. The computer-implemented method of claim 8, wherein the computer-implemented method further comprises enabling a system administrator to select an option associated with one of a subscription, a periodic query, or a manual download to identify any security vulnerability of the backup storage system which is resolved by at least one of a patch or a software release which is available for distribution to the backup storage system.

15. A computer program product, comprising a non-transitory computer-readable medium having a computer-readable program code embodied therein to be executed by one or more processors, the program code including instructions to:
train machine-learning models to identify historical activities, performed by users of backup storage systems, which comprise at least one of atypical activities or resemblances to malicious activities;
identify, by the machine-learning models, activities, performed by any user of a backup storage system, which comprise at least one of any of the atypical activities or a resemblance to any of the malicious activities;
determine activity scores, corresponding to the identified activities, wherein each activity score is related to a corresponding level of security risk;
output a security health score based on the activity scores;
isolate the backup storage system and enable another backup storage system to output another security health score based on one of the activity scores associated with the backup storage system, in response to a determination that the security health score is less than a threshold; and
output an updated security health score based on any change to any identified activity.

16. The computer program product of claim 15, wherein identifying the activities is based on one or more of the following: 1) one of an amount of data which is accessed or an amount of data files transferred by one of a system user or an application that functions as a user, 2) at least one of a time or a location for a login by the system user, 3) a command for storing a passphrase for a system onto a disk, 4) a command for deleting at least a part of one of a file system, a cloud storage, or a Merkle tree, 5) a data file that has similarities to at least one of a signature or an attack pattern for an instance of malware, 6) data which is from at least one of network traffic or a system log, or 7) at least one of a header, content, or user behavior that is associated with an email and has similarities to a phishing email.

17. The computer program product of claim 15, wherein outputting the security health score comprises weighing each of the activity scores by a corresponding weight which is determined based on an analysis of historical uses of activity scores to produce security health scores and subsequent security risks identified relative to each of the activity scores, wherein weighing each of the activity scores comprises at least one of determining a sum of each product of each activity score and a corresponding weight, or determining a product of each activity score to which an exponential function of a corresponding weight has been applied.

18. The computer program product of claim 15, wherein isolating the backup storage system comprises at least one of 1) disabling network access, 2) implementing a firewall rule, 3) blocking a suspicious process, or 4) outputting an alert which enables a system administrator to identify and resolve a security risk, and the other security health score being based on one of the activity scores associated with the backup storage system comprises adjusting at least one of a weight corresponding to another activity score that is associated with the other backup storage system and which corresponds to the activity score, or a relationship between the other security health score and a corresponding threshold.

19. The computer program product of claim 15, wherein the program code includes further instructions to lower the security health score below an additional threshold, in response to a time differential, between a previous time when the alert was output and a current time when a system administrator has yet to acknowledge the alert, exceeding a time threshold.

20. The computer program product of claim 15, wherein the program code includes further instructions to enable a system administrator to select an option associated with one of a subscription, a periodic query, or a manual download to identify any security vulnerability of the backup storage system which is resolved by at least one of a patch or a software release which is available for distribution to the backup storage system.
